(19) United States
(12) Patent Application Publication
(10) Pub. No.: US 2007/0125849 A1
(43) Pub. Date: Jun. 7, 2007

(54) Checkout system

(75) Inventors: Danny Hugh Addison, Durham, NC (US); Richard Hunter Harris, Raleigh, NC (US); Michael Edmund Lee, Ponte Vedra Beach, FL (US); Robert Andrew Myers, Cary, NC (US); Robert Paul Tennant, Apex, NC (US)

Correspondence Address: IBM CORPORATION, PO BOX 12195, DEPT YXSA, BLDG 002, RESEARCH TRIANGLE PARK, NC, 27709, US

(73) Assignee: INTERNATIONAL BUSINESS MACHINES CORPORATION, ARMONK, NY (US)

(21) Appl. No.: 11/294,209

(22) Filed: Dec. 5, 2005

(51) Int. Cl. G06K 15/00

(52) U.S. Cl. 235/383

(57) ABSTRACT

The present invention provides a checkout system with a change dispensing system for providing change in respect of a payment made for goods being purchased. The change dispensing system comprises a receptacle into which change is deposited and the receptacle is mounted in a counter surface of the checkout system where it is in easy view of the customer and where change which accidentally exits from the receptacle is likely to remain on the counter surface and not fall to the floor. Preferably a coin dispensing system is mounted in the checkout system above the counter and a channel guides coins from the change dispensing system to the receptacle under the force of gravity.

### BACKGROUND TO THE INVENTION

1. Field of the Invention

The present invention is related to checkout terminals and more particularly to dispensing change at checkout terminals and preferably at self checkout terminals.

2. Background to the Invention

Self checkout terminals which comprise a counter, a payment input system, and a change dispensing system, are now commonplace in retail situations. For example, in a typical application such as in a grocery store, a scanner is housed in the counter and the customer identifies items for purchase by using the scanner to scan a barcode for each item. Once all items are scanned payment is made for the scanned items in the form of either a debit/credit card or cash using the payment input system. If cash is used for payment and an overpayment is made, change is dispensed by the change dispensing system.

When paying with cash, the cash provided for payment and the cash provided as change may comprise coins and/or notes/bills. As a result, the payment input system comprises a coin acceptor and a note acceptor, and these are generally mounted above the counter for ease of access by a customer. Further the change dispensing system comprises a coin dispenser and a note dispenser and each have an associated receptacle into which appropriate change is deposited for collection by the customer. The coin and note dispensers are mounted beneath the counter, and their associated receptacles mounted on a vertical side of the checkout. This is due to their relatively large size of the dispensers and the space available beneath the counter.

However, this design of checkout terminal results in problems associated with the dispensing of change. For example, because the change is dispensed beneath the counter and outside of the normal view of a customer, some customers are prone to forget to take their change. For example, because the receptacles associated with the change dispensers are separate some customers are prone to take change dispensed from one dispenser but not the other. Further, for example, because the receptacle associated with the coin dispenser is mounted on a vertical side of the checkout, coins are prone to fall out of the receptacle and onto the floor, for example when a customer attempts to retrieve coins from the receptacle. This inconveniences the customer and further, if a coin disappears, for example under the checkout system or other adjacent equipment of a store, this introduces delays whilst the customer seeks replacement coins from an employee of the store.

### SUMMARY OF THE INVENTION

Accordingly the present invention provides a checkout system comprising: a counter surface suitable for placing items to be purchased; a payment input system for accepting a payment for items to be purchased; and a change dispensing system for providing change in respect of a payment, the change dispensing system comprising: a receptacle, mounted in the counter surface, into which change is deposited; and a coin dispenser configured to deposit coins into the receptacle.

Advantageously by mounting the receptacle in the counter surface it is in good view of a customer using the checkout system. This makes it less likely that the customer will forget to collect any change deposited into it. Further any coins which accidentally exit the receptacle are likely to remain on the counter rather than fall to the floor.

Preferably the receptacle is mounted in the counter surface such that the upper surface of the receptacle is substantially level with upper surface of the counter. This ensures that the receptacle does not obstruct the movement of items over the counter surface.

Preferably the change dispensing system further comprises a note/bill dispenser configured to deposit notes/bills into the receptacle, this giving a single location from which the customer can collect both coins and notes/bills which make up their change.

Optionally the payment input system is configured to further deposit coins returned from a payment into the receptacle, thus giving a single location from which a customer can obtain their change/returned coins.

Optionally, if the change dispensing system comprises a note dispenser configured to deposit notes into the receptacle, the receptacle includes an inlet through which notes are deposited into the receptacle and the inlet comprises a light emitter unit and a light sensor unit. The light emitter and sensor units are configured such that the view from the sensor to the emitter is blocked if there is a note in the inlet. This enables a warning to be provided to the customer if notes are left in the inlet for more than a predetermined time. For example the system may further comprise a sound generator which is configured to generate a sound warning, for example a buzz, when the view from the sensor to the emitter is blocked for a predetermined period of time. Alternatively, for example, a light warning could be used, for example a flashing light.

Preferably the checkout system further comprises a channel for guiding coins from the change dispensing system to the receptacle under the effect of gravity. For example, the channel comprises a chute for guiding rolling coins, the chute having at least an approximately 15 degree downward slope toward the receptacle along its length. For example the chute comprises at least one bend, each bend being of at least an approximately 50 mm radius. This ensures that coins which enter the chute reliably fall under the effect of gravity into the receptacle.

### BRIEF DESCRIPTION OF THE DRAWINGS

Some of the purposes of the invention having been stated, others will appear as the description proceeds, when taken in connection with the accompanying drawings, in which:

FIG. 1 is an illustration of an example prior art self checkout system;

FIG. 2 is an illustration of a self checkout system of the preferred embodiment of the present invention.

FIG. 3 is an illustration of the payment and change dispensing systems of the self checkout system of FIG. 2.

FIG. 4 is a illustration of a channel for guiding coins from a coin dispenser to a change receptacle.

FIG. 5 is an illustration of the change receptacle of FIGS. 2 and 3.

### DETAILED DESCRIPTION OF THE ILLUSTRATED EMBODIMENTS

In the following description of the exemplary embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

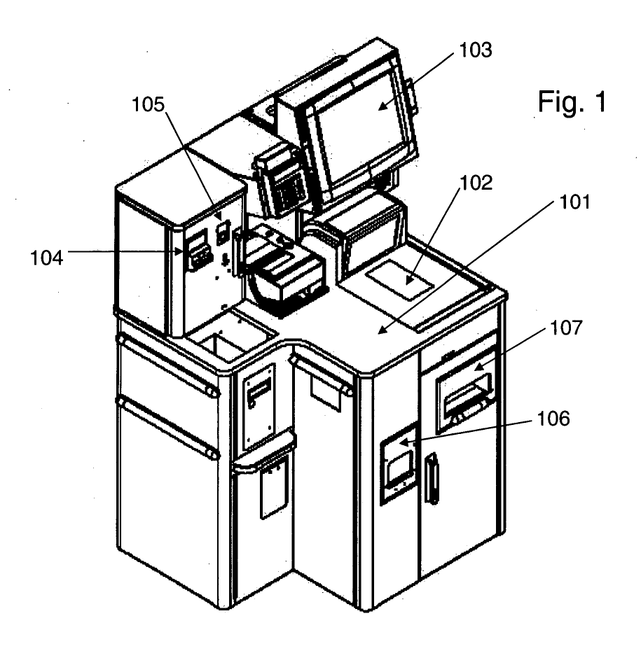

FIG. 1 is illustrates an IBM 4845 170 self checkout system which is an example of a prior art self checkout system. The system comprises a counter 101 into which a scanner 102 is mounted for the scanning of items to be purchased, a display 103 for providing information to a customer, a payment input system and a change dispensing system. The payment input system, which is used to provide notes/bills and/or coins as payment for scanned items, includes slot 104 for the input of notes and a slot 105 for the input of coins. The slots of the payment input system are mounted above counter 101 for ease of access by a customer. The change dispensing system, which is used to provide notes/bills and/or coins as change for an overpayment, includes receptacle 107 for the depositing of notes/bills and receptacle 106 for the depositing of coins, each for collection by the customer. The receptacles are mounted below the counter on a vertical side of the counter due to the size of the notes/bill and coins dispensers which deposit the change into the receptacles.

As previously discussed a problem with the self checkout system of FIG. 1 is the location in which the receptacle of the change dispensing system are mounted which can lead to problems such as, for example, a customer forgetting to collect their change, and/or change falling out of its associated receptacle and onto the floor.

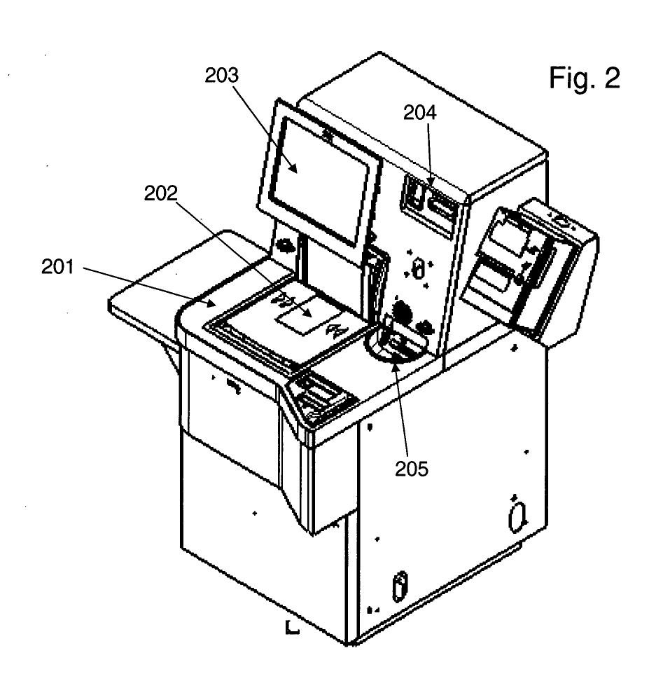

FIG. 2 illustrates a self checkout system according to the preferred embodiment of the present invention. The system comprises a counter 201 into which a scanning device 202 is mounted, a display 203 for providing information to a customer, a payment input system, and a change dispensing system. The payment input system, which is used to provide notes/bills and/or coins as payment for scanned items, includes slots 204 for the input of notes and coins. The slots 204 are mounted above counter 201 for ease of access by a customer. The change dispensing system, which is used to provide notes/bills and/or coins as change for an overpayment, includes a single cup-like receptacle 205 for the depositing of both notes/bills and coins for the collection by the customer. The receptacle 205 is mounted into the counter 201 such that the top surface of the receptacle is substantially flush with the surface of the counter such that movement of items on the counter surface is not obstructed by the receptacle. Further the receptacle is mounted in a place which is easily accessible and within the normal view of a customer using the self checkout and further in a more intuitive place directly beneath the payment input slots.

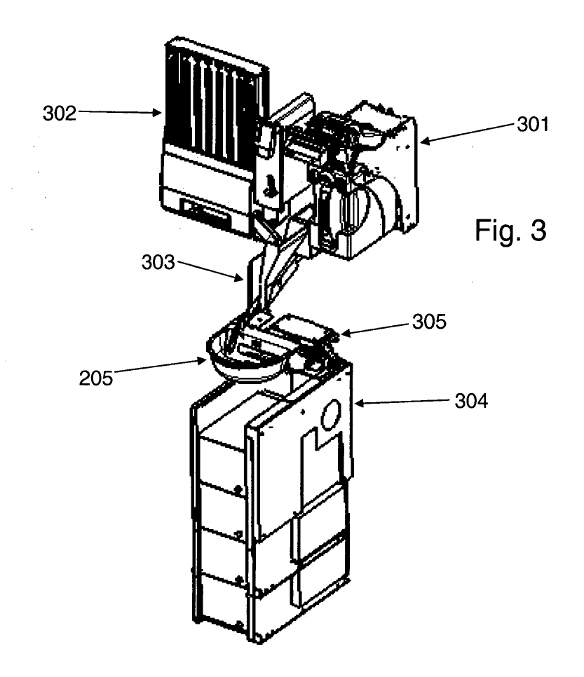

FIG. 3 is an illustration of the arrangement of the payment and change dispensing systems of the checkout system of FIG. 2. The figure shows a payment input system 301 and the components of the change dispensing system. The change dispensing system comprises a coin dispenser 302 which is mounted behind the display 203 of FIG. 2 in a position where it is easily accessible to an operator and further where it is at higher level than the receptacle 205. Channel 303 is configured to provide a guide for coins from an exit of the coin dispenser 302, and from an exit of the payment input system (for rejected/returned coins), to an inlet of the coin receptacle 205. Coins which enter channel 303 fall, under the effect of gravity, into receptacle 205. The change dispensing system further comprises note dispenser 304 which deposits notes into receptacle 205 via channel 305. Channel 305 includes a roller mechanism for moving notes which are output from the note dispenser, up to an inlet into receptacle 205.

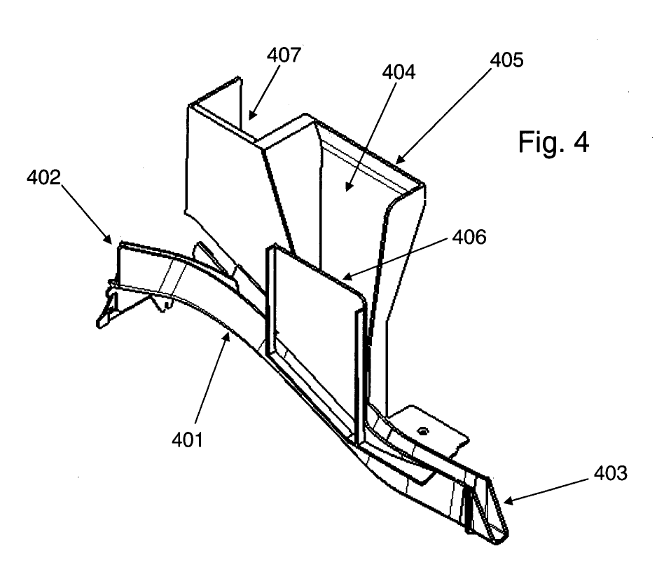

FIG. 4 is a more detailed illustration of channel 303 of FIG. 3. The channel includes a chute 401 with an inlet 402 and an outlet 403. For example, a coin enters the chute through inlet 401 from coin dispenser 302 of FIG. 3, rolls down chute 401 under the effect of gravity, and exits the chute through outlet 403 into receptacle 205 of FIG. 3. The channel further includes a second inlet 404 which is defined by walls 405 and 406. For example, a coin rejected/returned from input system 301 of FIG. 3 is dropped into inlet 404, falls into chute 401 somewhere along its length, rolls down chute 401 under the effect of gravity, and exits the chute through outlet 403 into receptacle 205 of FIG. 3. For example, for US coinage chute 401 provides a continuous slope of between approximately 15 and 20 degrees to horizontal and no turns of less than approximately 50 mm radius to ensure that all coins which enter the chute reliably exit outlet 403 under the effect of gravity. Note that the figure also shows an inlet 407 into which coins accepted by the input system 301 are dropped. These coins are guided into a separate receptacle (not shown) for retention.

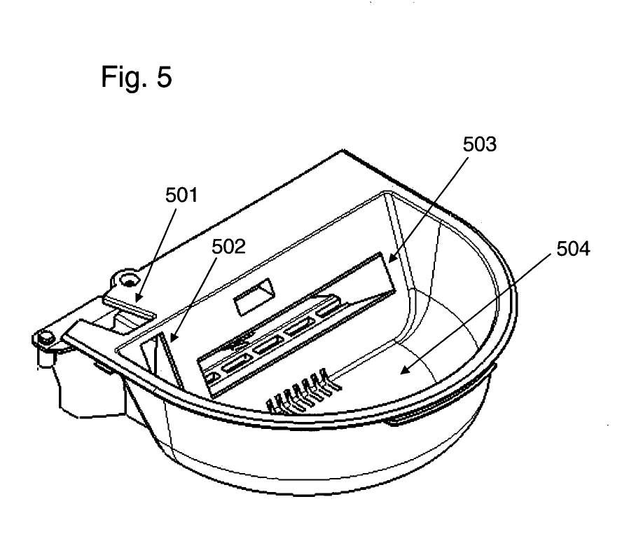

FIG. 5 is a more detailed illustration of receptacle 205 of FIGS. 2 and 3. The receptacle includes a slot 501 configured for receiving the outlet 403 of chute 401 of FIG. 4, an inlet 502 through which coins from the chute enter into the receptacle, and an inlet 503 through which notes/bills enter into the receptacle from channel 305 of FIG. 3. The base 504 of the receptacle is a short distance below the bottom of each inlet. This ensures that a coin/coins entering the receptacle through inlet 502 drop onto base 504 and as a result make a noise which is likely to attract the attention of a customer. Further this helps to prevent coins which enter the receptacle through inlet 502 from subsequently exiting the receptacle through inlet 503.

Inlet 503 further comprises (not shown in figure) a light emitter unit and an associated sensor unit which are arranged such that if a note/bill is in the inlet the view from the sensor to the emitter is blocked, whereas if there is not a note/bill in the inlet 503 the view from the sensor to the emitter is not blocked. When a note/bill is dispensed into the receptacle some portion of the note/bill is retained in the inlet and blocks the emitter from the sensor. Accordingly a time for which the sensor and emitter are blocked is measured and if this exceeds a predetermined value this is an indication that a customer has forgotten to collect their change. As a result a buzzer is sounded in an attempt to make the customer is aware of the problem.

Note that many modifications to the preferred embodiment of the present invention are possible without departing from the scope of the present invention.

For example, with reference to FIGS. 2 and 3, the relative locations of each component of the checkout system can be moved, provided the receptacle 205 is mounted in the counter surface 201. For example, coin dispenser 302 and/or receptacle 205 could be relocated such that channel 303 is not required. Further a different style of checkout could be used with the same set or a different set of components and a different shape of counter surface 201.

For example the design of the channel 303 of FIGS. 3 and 4 may be different. For example, the chute 401 may be of any size and shape which ensures that coins are guided under the effect of gravity from change dispenser 302 to receptacle 205. Further, for example, provision of inlet 404 and the configuring of the channel to guide returned coins to receptacle 205 is optional. Further for example inlet 407 is optional.

For example the design of the receptacle of FIGS. 2, 3 and 5 may be different. The shape of the receptacle may be changed provided it performs a function of retaining change which is deposited into it. The location of slot 501 and inlets 503 and 504 may be different and further one or more may be omitted if the associated channels 303 and 305 simply drop coins/notes into the receptacle. For example if coins entering the receptacle are not required to make a noise in doing so, the bottom of inlet 502 could, for example, be level with the base 504 of the receptacle. Further inclusion of light emitter and sensor units in inlet 503 is optional.

Accordingly problems associated with dispensing change in the prior art have been addressed. Receptacle 205 is in plain view of the change of a customer and all change, including notes and coins, are deposited into it. Accordingly a customer can retrieve all of their change from one place and, as a result, are less likely to forget some/all of their change when compared to the prior art checkout system of FIG. 1. Preferably the sound coins falling down channel 303 and into receptacle 205 further naturally alerts a customer that their change/returned coins are available.

Further, for example, if any change, such as a coin, escapes from the receptacle 205 it is likely to remain on the counter surface where it can be easily retrieved by a customer rather than fall onto the floor. This reduces the likelihood of a delay in a checkout becoming available to a subsequent customer, for example, whilst a previous customer attempts to either retrieve coin from an awkward position or obtain a replacement for a lost coin.

A person skilled in the art will realize that many other modifications could be made to the preferred embodiment of the present invention with departing from the scope of the present invention as claimed in the claims.

Note the whilst the preferred embodiment has been described in terms of a self checkout system the present invention could equally be applied to a checkout system which is operated by, for example, an employee of a store in which the checkout system is installed.

In summary the present invention provides a checkout system with a change dispensing system for providing change in respect of a payment made for goods being purchased. The change dispensing system comprises a receptacle into which change is deposited and the receptacle is mounted in a counter surface of the checkout system where it is in easy view of the customer and where change which accidentally exits from the receptacle is likely to remain on the counter surface and not fall to the floor. Preferably a coin dispensing system is mounted in the checkout system above the counter and a channel guides coins from the change dispensing system to the receptacle under the force of gravity.

What is claimed is:

1. A checkout system comprising:
a counter surface suitable for placing items to be purchased;
a payment input system for accepting a payment for items to be purchased; and
a change dispensing system for providing change in respect of a payment, the change dispensing system comprising:
a receptacle, mounted in the counter surface, into which change is deposited; and
a coin dispenser configured to deposit coins into the receptacle.

2. The checkout system of claim 1 wherein the receptacle is mounted in the counter surface such that the upper surface of the receptacle is substantially level with counter surface.

3. The checkout system of claim 1 wherein the payment input system is configured to deposit returned coins into the receptacle.

4. The checkout system of claim 1 wherein the change dispensing system further comprises a note dispenser configured to deposit notes into the receptacle.

5. The checkout system of claim 4 wherein the receptacle includes an inlet through which notes are deposited into the receptacle the inlet comprising:
a light emitter unit; and
a light sensor unit;
wherein the light emitter an sensor unit are configured such that the view from the sensor to the emitter is blocked if there is a note in the inlet.

6. The checkout system of claim 5 further comprising a sound generator which is configured to generate a sound when the view from the sensor to the emitter is blocked for a predetermined period of time.

7. The checkout system of claim 1 further comprising a channel for guiding coins from the change dispensing system to the receptacle under the effect of gravity, the channel comprising a chute for guiding rolling coins, the chute having at least an approximately 15 degree downward slope toward the receptacle along its length.

8. The checkout system of claim 1 further comprising a channel for guiding coins from the change dispensing system to the receptacle under the effect of gravity, the channel comprising a chute for guiding rolling coins, the chute having at least at least one bend, each bend being of at least an approximately 50 mm radius.

9. A checkout system comprising:
a counter surface suitable for placing items to be purchased;
a payment input system for accepting a payment for items to be purchased; and
a change dispensing system for providing change in respect of a payment, the change dispensing system comprising:
a receptacle, mounted in the counter surface, into which change is deposited;
a coin dispenser configured to deposit coins into the receptacle; and
a note dispenser configured to deposit notes into the receptacle.

10. The checkout system of claim 9 wherein the receptacle is mounted in the counter surface such that the upper surface of the receptacle is substantially level with counter surface.

11. The checkout system of claim 9 wherein the payment input system is configured to deposit returned coins into the receptacle.

12. The checkout system of claim 9 further comprising a channel for guiding coins from the change dispensing system to the receptacle under the effect of gravity, the channel comprising a chute for guiding rolling coins, the chute having at least an approximately 15 degree downward slope toward the receptacle along its length.

13. The checkout system of claim 9 further comprising a channel for guiding coins from the change dispensing system to the receptacle under the effect of gravity, the channel comprising a chute for guiding rolling coins, the chute having at least at least one bend, each bend being of at least an approximately 50 mm radius.

14. A checkout system comprising:
a counter surface suitable for placing items to be purchased;
a payment input system for accepting a payment for items to be purchased; and
a change dispensing system for providing change in respect of a payment, the change dispensing system comprising:
a receptacle, mounted in the counter surface, into which change is deposited; and
a coin dispenser configured to deposit coins into the receptacle;
wherein the payment input system is configured to deposit returned coins into the receptacle.

15. The checkout system of claim 14 wherein the receptacle is mounted in the counter surface such that the upper surface of the receptacle is substantially level with counter surface.

16. The checkout system of claim 14 wherein the change dispensing system further comprises a note dispenser configured to deposit notes into the receptacle.

17. The checkout system of claim 16 wherein the receptacle includes an inlet through which notes are deposited into the receptacle the inlet comprising:
a light emitter unit; and
a light sensor unit;
wherein the light emitter an sensor unit are configured such that the view from the sensor to the emitter is blocked if there is a note in the inlet.

18. The checkout system of claim 17 further comprising a sound generator which is configured to generate a sound when the view from the sensor to the emitter is blocked for a predetermined period of time.

19. The checkout system of claim 14 further comprising a channel for guiding coins from the change dispensing system to the receptacle under the effect of gravity, the channel comprising a chute for guiding rolling coins, the chute having at least an approximately 15 degree downward slope toward the receptacle along its length.

20. The checkout system of claim 14 further comprising a channel for guiding coins from the change dispensing system to the receptacle under the effect of gravity, the channel comprising a chute for guiding rolling coins, the chute having at least at least one bend, each bend being of at least an approximately 50 mm radius.
